(19) United States
(12) Patent Application Publication
(10) Pub. No.: US 2014/0256887 A1
(43) Pub. Date: Sep. 11, 2014

(54) PREPARATION OF POLYAMIDES BY HYDROLYTIC POLYMIERIZATION AND MULTIPLE EXTRACTION

(71) Applicant: BASF SE, Ludwigshafen (DE)

(72) Inventors: Gad Kory, Gaiberg (DE); Silke Biedasek, Mannheim (DE); Faissal-Ali El-Toufaili, Ludwigshafen (DE); Achim Stammer, Freinsheim (DE); Reinhard Lang, Neustadt (DE); Dirk Meckelnburg, Limburgerhof (DE)

(73) Assignee: BASF SE, Ludwigshafen (DE)

(21) Appl. No.: 14/199,436

(22) Filed: Mar. 6, 2014

Related U.S. Application Data
(60) Provisional application No. 61/773,849, filed on Mar. 7, 2013.

(51) Int. Cl. C08G 69/48

(52) U.S. Cl. CPC C08G 69/48
USPC 525/420

(57) ABSTRACT

The present invention relates to a process for preparing polyamides, comprising a hydrolytic polymerization and at least two extraction steps which are not in immediate succession.

### BACKGROUND OF THE INVENTION

The present invention relates to a process for preparing polyamides, comprising a hydrolytic polymerization and at least two extraction steps which are not in immediate succession.

### STATE OF THE ART

Polyamides are one of the polymers produced on a large scale globally and, in addition to the main fields of use in fibers, materials and films, serve for a multitude of further end uses. Among the polyamides, polyamide-6 with a proportion of about 57% is the most commonly produced polymer. The conventional process for preparing polyamide-6 (polycaprolactam) is the hydrolytic polymerization of ε-caprolactam, which is still of very great industrial significance. Conventional hydrolytic preparation processes are described, for example, in Ullmann's Encyclopedia of Industrial Chemistry, Online Edition Mar. 15, 2003, vol. 28, p. 552-553 and Kunststoffhandbuch, 3/4 Technische Thermoplaste: Polyamide [Plastics Handbook, 3/4 Industrial Thermoplastics: Polyamides], Carl Hanser Verlag, 1998, Munich, p. 42-47 and 65-70.

In the first step of the hydrolytic polymerization, a portion of the lactam used reacts through the action of water with ring opening to give the corresponding ω-aminocarboxylic acid. The latter then reacts with further lactam in polyaddition and polycondensation reactions to give the corresponding polyamide. In a preferred variant, ε-caprolactam reacts through the action of water with ring opening to give aminocaproic acid and then further to give polyamide-6. The hydrolytic polymerization can be effected in one or more stages. In general, the polycondensation and polyaddition are effected in a vertical tubular reactor (VK tube). This German abbreviation “VK” stands for “vereinfacht kontinuierlich” [“simplified continuous”]. Optionally, it is possible to use a plant with a prepolymerization stage at elevated pressure. The use of such a preliminary reactor reduces the residence time required for the ring-opening reaction of the ε-caprolactam. At the end of the vertical tubular reactor (VK tube), a polyamide melt having a composition close to the chemical equilibrium and composed of polyamide, lactam monomer, oligomers and water is obtained. The content of oligomers and monomers may, for example, be 8 to 15% by weight and the viscosity number of the crude polyamide, which is directly related to the molar mass and hence the processing properties, is generally between 110 and 160 ml/g.

Many end uses, for example for production of films for packaging materials, require a low residual monomer content in the polyamide, and so the crude polyamide, prior to the further processing thereof, is generally subjected to an at least partial removal of monomers and oligomers.

To reduce the content of low molecular weight components, pellets of crude polyamide particles are generally first obtained from the product of the hydrolytic polymerization and these are then extracted with an extractant, in order to remove remaining monomers and oligomers. This is frequently effected by continuous or batchwise extraction with hot water, as described, for example, in EP 0 117 495 A2, DE 25 01 348 A and DE 27 32 328 A. For purification of crude polyamide-6, extraction with caprolactam-containing water (WO 99/26996 A2) or treatment in a superheated water vapor stream (EP 0 284 986 A1) is also known. For reasons of environmental protection and of economic viability, the extracted constituents, more particularly the caprolactam and the cyclic oligomers in the case of polyamide-6, are recycled into the process. The extraction is typically followed by drying of the extracted polyamide.

Many applications require polyamides having relatively high molecular weights which are not achieved by the hydrolytic polymerization alone. To increase the molecular weight or the viscosity of the polyamide, a postcondensation is then performed after the extraction, the polyamide preferably being in the solid phase. For this purpose, the pellets can be heat treated at temperatures below the melting point of the polyamide, in the course of which there is continuation of the polycondensation in particular. This leads to an increase in the molecular weight and hence to an increase in the viscosity number of the polyamide. In general, the viscosity number of the polyamide-6 after extraction and postpolymerization is 180 to 260 ml/g.

Postcondensation and drying are frequently performed in one step (WO 2009/153340 A1, DE 199 57 664 A1).

DD 2090899 describes processes for vacuum melt demonomerization in which an upstream polyamide extraction involves contacting the polyamide melt with liquid caprolactam.

DD 227140 describes a process for preparing polyamide having a degree of polymerization DP>200. The process features at least 5 successive stages. At the start of each drying stage, the surface of the molten polyamide is adjusted to >4 cm²/g of polyamide and the maximum diffusion distance of the water in the melt is adjusted to <3 mm.

WO 03/040212 discloses a method for preparing polyamide-6 by hydrolytic polymerization of ε-caprolactam under the action of water. The dewatering is achieved by the increase in the surface area of the melt.

WO 2009/153340 A1 describes a continuous process for the multistage drying and postcondensation of polyamide pellets in the solid phase, wherein

1) the predrying process is carried out in a continuous drying apparatus which is operated with inert gas or steam, or with a mixture of inert gas and steam, using a pellet temperature in the range from 70 to 200° C., and
2) the subsequent continuous postcondensation is carried out in a separate vertical duct with moving bed at a pellet temperature in the range from 120 to 210° C., where the duct is operated with inert gas or steam, or with a mixture of inert gas and steam, and the inert gas is introduced at at least two sites along the duct.

According to the teaching of WO 2009/153340, the process measures for increasing the molecular weight and for (partial) extraction are combined and are performed as a solid/gas extraction especially in the postcondensation. Since the second extraction is performed simultaneously with the postcondensation at temperatures greater than 120° C., there will necessarily be reformation of monomers (remonomerization) as a result of redissociation of polyamide. Thus, in spite of simultaneous treatment with steam and/or inert gas, the residual monomer content cannot be reduced satisfactorily. The lowest values for the residual monomer content are achieved according to WO 2009/153340 in examples 2 and 3 and are 1200 ppm. In comparison, it is possible by the process according to the invention, through multiple extraction, to achieve much lower values, which rise only insignificantly even in the case of subsequent drying.

An alternative route, which is not utilized significantly on the industrial scale, for preparation of polyamides is the polycondensation of amino nitriles, for example the preparation of polyamide-6 from 6-aminocapronitrile (ACN). According to a customary procedure, this process comprises a nitrile hydrolysis and subsequent amine amidation, which is generally performed in separate reaction steps in the presence of a heterogeneous catalyst, such as TiO₂. A multistage mode of operation has been found to be practicable, since the two reaction steps have different requirements in terms of water content and completeness of the reaction. In the case of this synthesis route too, it is in many cases advantageous to subject the polymer obtained to a purification for removal of monomers/oligomers.

WO 00/47651A1 describes a continuous process for preparing polyamides by reaction of at least one aminocarbonitrile with water.

The known processes for preparing polyamides by hydrolytic polymerization are still in need of improvement. For instance, the residual monomer content, specifically of ε-caprolactam, at the start of postpolymerization below the melting point of the polyamide, is well below the equilibrium value. Thus, during the final polymerization, a reverse polyaddition (remonomerization) reaction can take place, such that the residual monomer content of the polyamide increases again in the last step of the preparation process.

It is therefore an object of the present invention to provide an improved hydrolytic process for preparing polyamides, in which the aforementioned disadvantages are avoided. More particularly, it is to be possible by this process to provide a product having very low residual monomer content.

It has now been found that, surprisingly, this object is achieved when the reaction mixture which is obtained in the hydrolytic polymerization and comprises polyamide, water, unconverted monomers and oligomers is subjected to a pelletization, then the pellets are subjected to a first extraction, at least partly removing unconverted monomers and oligomers, then the polyamide obtained after the first extraction is subjected to a postpolymerization in the solid phase and the product of the postpolymerization is then subjected to a further extraction. Thereafter, further workup steps, for example a drying operation, may follow. The process according to the invention can achieve polyamides with lower residual monomer content compared to conventional processes. More particularly, it is possible to provide polyamides simultaneously having a low residual content of monomeric lactam and of cyclic dimer.

### SUMMARY OF THE INVENTION

The invention therefore provides a process for preparing polyamides, in which
a) a monomer composition comprising at least one lactam or at least one aminocarbonitrile and/or oligomers of these monomers is provided,
b) the monomer composition provided in step a) is converted in a hydrolytic polymerization at elevated temperature in the presence of water to obtain a reaction product comprising polyamide, water, unconverted monomers and oligomers,
c) the reaction product obtained in step b) is subjected to shaping to obtain polyamide particles,
d) the polyamide particles obtained in step c) are treated with at least one first extractant,
e) the extracted polyamide particles obtained in step d) are fed into a reaction zone for postpolymerization,
f) the polyamide obtained in step e) is treated with at least one second extractant.

In a specific embodiment, the laden extractant obtained in step f) is subsequently used for extraction in step d).

More particularly, the extracted polyamide obtained in step f) of the process according to the invention is additionally subjected to drying (step g)).

The invention further provides polyamides obtainable by the process described above and hereinafter. These polyamides feature a very low residual monomer content unachievable by processes known from the prior art.

The invention further provides for the use of polyamides obtainable by the process described above and hereinafter, especially for production of pellets, films, fibers or moldings.

### DETAILED DESCRIPTION OF THE INVENTION

In the context of the present invention, “monomer” is understood to mean a low molecular weight compound as used in the preparation of the polyamide by hydrolytic polymerization for introduction of a single repeat unit. These include the lactams and aminocarbonitriles used. These also include any comonomers used for preparation of the polyamides, such as ω-aminocarboxylic acids, ω-aminocarboxamides, ω-aminocarboxylic salts, ω-aminocarboxylic esters, diamines and dicarboxylic acids, dicarboxylic acid/diamine salts, dinitriles and mixtures thereof.

In the context of the present invention, an oligomer is understood to mean a compound as formed in the preparation of the polyamides by reaction of at least two of the compounds which form the individual repeat units. These oligomers have a lower molecular weight than the polyamides prepared in accordance with the invention. The oligomers include cyclic and linear oligomers, specifically cyclic dimer, linear dimer, trimer, tetramer, pentamer, hexamer and heptamer. Standard processes for determining the oligomeric components of polyamides generally cover the components up to the heptamer.

The viscosity number (Staudinger function, referred to as VN or J) is defined as VN=1/c×(η−ηₛ)/ηₛ. The viscosity number is directly related to the mean molar mass of the polyamide and gives information about the processibility of a polymer. The viscosity number can be determined to EN ISO 307 with an Ubbelohde viscometer.

The process according to the invention has the following advantages:
The final extraction in step f) is the last process step, or the extraction step is not followed by any further process step associated with any significant thermal stress on the polymer, as occurs, for example, in the postpolymerization. Thus, the reformation of monomers and/or oligomers, as occurs at relatively high temperatures as an equilibrium reaction, is avoided. Thus, very low residual monomer contents are enabled.
During the first extraction in step d), it is already possible to effect postcrystallization of the product of the hydrolytic polymerization. The proportion of crystalline product has an influence on the rate of postpolymerization in step e). This can proceed more quickly than if it were to be performed prior to the extraction. The process according to the invention thus also features a short residence time in the postpolymerization.

### Step a)

In step a) of the process according to the invention, a monomer mixture comprising at least one lactam or at least one aminocarbonitrile and/or oligomers of these monomers and possibly further components is converted under polyamide-forming reaction conditions, forming a polyamide.

According to the invention, polyamides are understood to mean homopolyamides, copolyamides and polymers incorporating at least one lactam or nitrile and at least one further monomer and having a content of at least 60% by weight of polyamide base units, based on the total weight of the monomer base units in the polyamide.

Homopolyamides derive from an aminocarboxylic acid or a lactam and can be described by a single repeat unit. Polyamide-6 base units can be formed, for example, from caprolactam, aminocapronitrile, aminocaproic acid or mixtures thereof. Examples of homopolyamides are nylon-6 (PA 6, polycaprolactam), nylon-7 (PA 7, polyenantholactam or polyheptanamide), nylon-10 (PA 10, polydecanamide), nylon-11 (PA 11, polyundecanolactam) and nylon-12 (PA 12, polydodecanolactam).

Copolyamides derive from several different monomers, the monomers each being joined to one another by an amide bond.

Possible copolyamide units may derive, for example, from lactams, aminocarboxylic acids, dicarboxylic acids and diamines. Preferred copolyamides are polyamides formed from caprolactam, hexamethylenediamine and adipic acid (PA 6/66). Copolyamides may comprise the polyamide units in various ratios.

Polyamide copolymers comprise, as well as the polyamide base units, further base units not joined to one another by amide bonds. The proportion of comonomers in polyamide copolymers is preferably not more than 40% by weight, more preferably not more than 20% by weight, especially not more than 10% by weight, based on the total weight of the base units of the polyamide copolymer.

The polyamides prepared by the process according to the invention are preferably selected from polyamide-6, polyamide-11, polyamide-12, and the copolyamides and polymer blends thereof. Particular preference is given to polyamide-6 and polyamide-12; polyamide-6 is especially preferred.

The monomer mixture provided in step a) preferably comprises at least one C₅- to C₁₂-lactam and/or an oligomer thereof. The lactams are especially selected from ε-caprolactam, 2-piperidone (δ-valerolactam), 2-pyrrolidone (γ-butyrolactam), capryllactam, enantholactam, lauryllactam, and the mixtures and oligomers thereof. Particular preference is given to providing, in step a), a monomer mixture comprising ε-caprolactam, 6-aminocapronitrile and/or an oligomer thereof. More particularly, in step a), a monomer mixture comprising exclusively ε-caprolactam or exclusively 6-aminocapronitrile as a monomer component is provided.

In addition, it is also possible that, in step a), a monomer mixture comprising, in addition to at least one lactam or aminocarbonitrile and/or oligomer thereof, at least one monomer (M) copolymerizable therewith is provided.

Suitable monomers (M) are dicarboxylic acids, for example, aliphatic C₄₋₁₀-alpha,omega-dicarboxylic acids such as succinic acid, glutaric acid, adipic acid, pimelic acid, suberic acid, azelaic acid, sebacic acid and dodecanedioic acid. It is also possible to use aromatic C₈₋₂₀-dicarboxylic acids such as terephthalic acid and isophthalic acid.

As diamines suitable as monomers (M), it is possible to use α,ω-diamines having four to ten carbon atoms, such as tetramethylenediamine, pentamethylenediamine, hexamethylenediamine, heptamethylenediamine, octamethylenediamine, nonamethylenediamine and decamethylenediamine. Particular preference is given to hexamethylenediamine.

Among the salts of said dicarboxylic acids and diamines suitable as monomers (M), the salt of adipic acid and hexamethylenediamine, called AH salt, is especially preferred.

Suitable monomers (M) are also lactones. Preferred lactones are, for example, ε-caprolactone and/or γ-butyrolactone.

In the preparation of the polyamides, it is possible to use one or more chain transfer agents, for example aliphatic amines or diamines such as triacetonediamine or mono- or dicarboxylic acids such as propionic acid and acetic acid or aromatic carboxylic acids such as benzoic acid or terephthalic acid.

### Step b)

The conversion of the monomer mixture provided in step a) in a hydrolytic polymerization in step b) can be effected by standard processes known to those skilled in the art. Such a process is described, for example, in Kunststoff Handbuch, 3/4 Technische Thermoplaste Polyamide, Carl Hanser Verlag, 1998, Munich, p. 42-47 and 65-70. This disclosure is fully incorporated here by reference.

Preferably, in step b), hydrolytic polymerization is accomplished by subjecting a lactam to ring opening under the action of water. This involves, for example, at least partly cleaving the lactam to give the corresponding aminocarboxylic acid, which is then polymerized further in the subsequent step by polyaddition and polycondensation. If, in a preferred embodiment, in step a), a monomer mixture comprising caprolactam is provided, the latter is at least partly opened under the action of water to give the corresponding aminocaproic acid and then reacts with polycondensation and polyaddition to give polyamide-6. In an alternative version, in step b), an aminocarbonitrile, specifically 6-aminocapronitrile, is subjected to a polymerization under the action of water and optionally in the presence of a catalyst.

The conversion in step b) is preferably continuous.

Preferably, the hydrolytic polymerization in step b) is effected in the presence of 0.1 to 25% by weight of added water, more preferably of 0.5 to 20% by weight of added water, based on the total amount of monomers and oligomers used. Additional water formed in the condensation reaction is not included in this stated amount.

The hydrolytic polymerization in step b) can be effected in one or more stages (for example two stages). When the hydrolytic polymerization in step b) is performed in one stage, the starting concentration of water is preferably 0.1 to 4% by weight based on the total amount of monomers and oligomers used. When the hydrolytic polymerization in step b) is performed in two stages, the VK tube is preferably connected downstream of a preliminary pressure stage, for example a preliminary pressure reactor. In the preliminary pressure stage, the starting concentration of water is preferably 2 to 25% by weight, more preferably 3 to 20% by weight, based on the total amount of monomers and oligomers used.

In a specific version, the monomer mixture provided in step a) consists of at least one lactam and the hydrolytic polymerization in step b) is effected in the presence of 0.1 to 4% by weight of water, based on the total amount of the lactam used. The lactam is specifically ε-caprolactam.

The hydrolytic polymerization in step b) can be effected in the presence of at least one regulator, such as propionic acid. If a regulator is used in step b) and the hydrolytic polymerization is performed in two stages using a preliminary pressure stage, the regulator can be used in the preliminary pressure stage and/or in the second polymerization stage. In a specific version, the hydrolytic polymerization in step b) is not effected in the presence of a regulator.

The polyamides prepared in the process according to the invention may additionally comprise customary additives such as matting agents, e.g. titanium dioxide, nucleators, e.g. magnesium silicate, stabilizers, e.g. copper(I) halides and alkali metal halides, antioxidants, reinforcers, etc., in customary amounts. The additives are generally added before, during or after the hydrolytic polymerization (step b). Preference is given to adding the additives before the hydrolytic polymerization in step b).

The conversion in step b) can be effected in one or more stages (for example two stages). In a first embodiment, the conversion in step b) is executed in one stage. In this case, the lactam or aminocarbonitrile and any oligomers thereof are preferably reacted with water and optionally additives in a reactor.

Suitable reactors are the reactors which are known to those skilled in the art and are customary for preparation of polyamides. Preferably, the hydrolytic polymerization in step b) is effected in a polymerization tube or a bundle of polymerization tubes. Specifically, for the hydrolytic polymerization in step b), at least one VK tube is used. This German abbreviation “VK” stands for “vereinfacht kontinuierlich” [“simplified continuous”]. In a multistage version of the conversion in step b), preferably at least one of the stages is effected in a VK tube. In a two-stage version of the conversion in step b), the second stage is preferably effected in a VK tube. In a two-stage version of the conversion in step b), the first stage can be effected in a preliminary pressure reactor. In the case of use of an aminocarbonitrile, the conversion in step b) is generally effected in two or more stages, the first stage preferably being effected in a preliminary pressure reactor.

In a suitable embodiment, polyamide-6 is prepared in a multistage process, specifically a two-stage process. Caprolactam, water and optionally at least one additive, for example a chain transfer agent, are supplied to the first stage and converted to a polymer composition. This polymer composition can be transferred into the second stage under pressure or by means of a melt discharge pump. This is preferably effected by means of a melt distributor.

The hydrolytic polymerization in step b) is preferably effected at a temperature in the range from 240 to 280° C. In a multistage version of the hydrolytic polymerization in step b), the individual stages can be effected at the same or at different temperatures and pressures. In the case of performance of a polymerization stage in a tubular reactor, specifically a VK tube, the reactor may have essentially the same temperature over the entire length. Another possibility is a temperature gradient in the region of at least part of the tubular reactor. Another possibility is the performance of the hydrolytic polymerization in a tubular reactor having two or more than two reaction zones which are operated at different temperature and/or at different pressure. The person skilled in the art can select the optimal conditions as required, for example taking account of the equilibrium conditions.

When the hydrolytic polymerization in step b) is effected in one stage, the absolute pressure in the polymerization reactor is preferably within a range from about 1 to 10 bar, more preferably from 1.01 bar up to 2 bar. Particular preference is given to performing the one-stage polymerization at ambient pressure.

In a preferred version, the hydrolytic polymerization in step b) is performed in two stages. The upstream connection of a pressure stage makes it possible to achieve a process acceleration, by performing the rate-determining cleavage of the lactam, specifically of caprolactam, under elevated pressure under otherwise similar conditions to those in the second reaction stage. The second stage is then preferably effected in a VK tube as described above. The absolute pressure in the first stage is preferably within a range from about 1.5 to 70 bar, more preferably within a range from 2 to 30 bar. The absolute pressure in the second stage is preferably within a range from about 0.1 to 10 bar, more preferably from 0.5 bar up to 5 bar. More particularly, the pressure in the second stage is ambient pressure.

On exit from the VK tube, the polyamide melt is then subjected to shaping to obtain polyamide particles.

### Step c)

In step c) of the process according to the invention, the polyamide obtained in step b) is subjected to shaping to obtain polyamide particles.

Preferably, the polyamide obtained in step b) is first shaped to one or more strands. For this purpose, apparatuses known to those skilled in the art can be used. Suitable apparatuses are, for example, perforated plates, nozzles or die plates. Preferably, the reaction product obtained in step b) is shaped to strands in the free-flowing state and subjected in the form of strands of free-flowing reaction product to a comminution to give polyamide particles. The hole diameter is preferably within a range from 0.5 mm to 20 mm, more preferably 1 mm to 5 mm, most preferably 1.5 to 3 mm.

Preferably, the shaping in step c) comprises a pelletization. For pelletization, the polyamide obtained in step b), having been shaped to one or more strands, can be solidified and then pelletized. For example, Kunststoffhandbuch, 3/4 Technische Thermoplaste: Polyamide, Carl Hanser Verlag, 1998, Munich, p. 68-69 describes suitable measures. A specific shaping process is underwater pelletization, which is likewise known in principle to those skilled in the art.

### Step d)

In step d), the polyamide particles obtained in step c) are subjected to a first extraction.

Suitable processes and apparatuses for extraction of polyamide particles are known in principle to those skilled in the art.

Extraction means that the content of monomers and any dimers and further oligomers in the polyamide is reduced by treatment with an extractant. This can be accomplished industrially, for example, by continuous or batchwise extraction with hot water (DE 2501348 A, DE 2732328 A) or in a superheated water vapor stream (EP 0284968 W1).

Preference is given to extraction in step d) using a first extractant comprising water or consisting of water. In a preferred version, the first extractant consists solely of water. In a further preferred version, the first extractant comprises water and a lactam used for preparation of the polyamide and/or oligomers thereof. In the case of polyamide-6, it is thus also possible to extract using caprolactam-containing water, as described in WO 99/26996 A2. Preference is given to extraction in step d) using the laden extractant obtained in step f). Thus, the amount of wastewater in need of treatment can be minimized.

The temperature of the extractant is preferably within a range from 75 to 130° C., more preferably from 85 to 120° C.

The extraction can be effected continuously or batchwise. Preference is given to a continuous extraction.

In the extraction, the polyamide particles and the first extractant can be conducted in cocurrent or in countercurrent. Preference is given to extraction in countercurrent.

In a first preferred embodiment, the polyamide particles are extracted continuously in countercurrent with water at a temperature of 5100° C. and ambient pressure. In that case, the temperature is preferably within a range from 85 to 99.9° C.

In a further preferred embodiment, the polyamide particles are extracted continuously in countercurrent with water at a temperature of ≧100° C. and a pressure in the range from 1 to 2 bar absolute. In that case, the temperature is preferably within a range from 101 to 120° C.

For extraction, it is possible to use customary apparatuses known to those skilled in the art. In a specific version, extraction is accomplished using at least one pulsed extraction column.

The components present in the laden first extractant obtained in step d), selected from monomers and any dimers and/or oligomers, can be isolated for this purpose and recycled into step a) or b).

It is possible to subject the extracted polyamide obtained in step d) to drying. The drying of polyamides is known in principle to those skilled in the art. For example, the extracted pellets can be dried by contacting with dry air or a dry inert gas or a mixture thereof. Preference is given to using an inert gas, e.g. nitrogen, for drying. The extracted pellets can also be dried by contacting with superheated water vapor or a mixture thereof with a different gas, preferably an inert gas. For drying, it is possible to use customary driers, for example countercurrent driers, crosscurrent driers, pan driers, tumble driers, paddle driers, crossflow driers, cone driers, tower driers, fluidized beds, etc. A suitable version is batchwise drying in a tumble drier or cone drier under reduced pressure. A further suitable version is continuous drying in tubular driers, through which a gas which is inert under the drying conditions flows. In a specific version, drying is accomplished using at least one tower drier. Preferably, a hot inert gas which is inert under the postpolymerization conditions flows through the tower drier. A preferred inert gas is nitrogen.

### Step e)

In step e), the extracted polyamide obtained in step d) is fed into a reaction zone for postpolymerization.

Preferably, the polyamide particles obtained in step d), for postpolymerization in step e), are subjected to a solid phase polymerization. This involves polymerizing the polyamide in the solid phase. The polyamide undergoes a heat treatment, the temperature being below the melting point of the polyamide.

Suitable reaction zones in which the postpolymerization takes place are in principle apparatuses as also usable for drying, for example countercurrent driers, crosscurrent driers, pan driers, tumble driers, paddle driers, crossflow driers, cone driers, tower driers, fluidized beds, etc. Preference is given to using, as the reaction zone in which the postpolymerization takes place, at least one reactor, more preferably at least one tubular reactor. In a specific version, postpolymerization is accomplished using at least one tower drier. Preferably, a hot inert gas which is inert under the postpolymerization conditions flows through the tower drier. A preferred inert gas is nitrogen.

Suitable processes for postpolymerization of hydrolytically prepared polyamides are known in principle to those skilled in the art. The postpolymerization can be performed, for example, as described in WO 2009153340, EP 1235671 or EP 0732351.

The postpolymerization in step d) can be effected in one stage (in a single reaction zone). It can also be effected in more than one stage, for example in two stages, in a plurality of reaction zones which may be arranged in succession and/or in parallel. Preference is given to performing the postpolymerization in one stage.

In the postpolymerization, the temperature in the reaction zone is preferably within a range from 120 to 185° C., more preferably from 150 to 180° C.

In the postpolymerization, the pressure in the reaction zone is typically within a range from 1 mbar to 1.5 bar, more preferably from 500 mbar to 1.3 bar.

In the multistage postpolymerization, the polymerization apparatuses may be the same or different in terms of type and size. For example, it is possible to use two identical polymerization apparatuses, or two polymerization apparatuses of different sizes. For example, it is possible to operate two polymerization apparatuses in succession, in which case each has different residence time characteristics. For example, it is also possible to operate two polymerization apparatuses in succession, in which case each of the polymerization apparatuses has different pressure levels. For example, it is also possible to operate two polymerization apparatuses in succession, in which case different inert gas rates flow through each of the polymerization apparatuses. For example, it is also possible to operate two polymerization apparatuses in succession, in which case each of the polymerization apparatuses has different pressure levels and different inert gas rates flow through each of the polymerization apparatuses.

The temperature of the polyamide in the postpolymerization is typically controlled by means of heat exchangers, such as outer jackets, internal heat exchangers or other suitable apparatuses. In a preferred embodiment, the postpolymerization in step e) is effected in the presence of at least one inert gas. In that case, the temperature of the polyamide in the postpolymerization is controlled at least partly through the use of a hot inert gas.

In a first preferred embodiment, during the postpolymerization, hot inert gas flows through the reaction zone. Suitable inert gases are, for example, nitrogen, CO₂, helium, neon and argon, and mixtures thereof. Preference is given to using nitrogen.

In a further preferred embodiment, the postpolymerization in step e) is effected without mass transfer with the environment. “Postpolymerization without mass transfer with the environment” is understood to mean that, after the extracted polyamide particles obtained in step d) have been fed into the postpolymerization zone, no mass transfer takes place between the postpolymerization zone and the environment. More particularly, no gas stream is passed through the postpolymerization zone during the postpolymerization. Thus, during the postpolymerization in step e), there is no introduction and also no discharge of components, for example of water, from the vessel interior into the environment and vice versa.

The residence time in the reaction zone in step e) is preferably 15 hours to 100 hours, more preferably 25 hours to 55 hours.

In a preferred embodiment, the residence time of the polymer in step e) is selected such that the relative viscosity of the polyamide increases by at least 10%, preferably by at least 15%, more preferably by at least 20%, based on the relative viscosity of the polyamide before step d).

The relative viscosity of the polyamide is typically used as a measure for the molecular weight. The relative viscosity is determined in accordance with the invention at 25° C. as a solution in 96 percent by weight H₂SO₄ having a concentration of 1.0 g of polyamide in 100 ml of sulfuric acid. The determination of relative viscosity follows DIN EN ISO 307.

### Step f)

In step f), the polyamide particles obtained in step e) are subjected to a further extraction.

The extraction of polyamide particles is known in principle to those skilled in the art and is described in detail in step d).

Preference is given to extraction in step f) using a second extractant comprising water or consisting of water. In a preferred version, the second extractant consists solely of water. In a specific embodiment, in that case, it is recovered extractant which may still comprise small amounts of monomer and/or oligomer.

The temperature of the extractant in step f) is preferably within a range from 75 to 120° C.

The temperature of the extractant during the treatment in step f) is more preferably within a range from 50 to less than 120° C., particularly from 75 to 118° C., especially from 80 to 115° C., more especially from 85 to 110° C.

Preferably, polyamide is in the solid state (and not in the melt) during the treatment in step f).

The extraction in step f) can be effected continuously or batchwise. Preference is given to a continuous extraction.

In the extraction in step f), the polyamide particles and the first extractant can be conducted in cocurrent or in countercurrent. Preference is given to extraction in countercurrent.

In a first preferred embodiment, the polyamide particles are extracted continuously in countercurrent with water at a temperature of ≦100° C. and ambient pressure. In that case, the temperature is preferably within a range from 85 to 99.9° C.

In a further preferred embodiment, the polyamide particles are extracted continuously in countercurrent with water at a temperature of 00° C. and a pressure in the range from 1 to 2 bar absolute. In that case, the temperature is preferably within a range from 101 to less than 120° C.

The components present in the laden second extractant obtained in step f), selected from monomers and any dimers and/or oligomers, can be isolated for this purpose and recycled into step a) or b).

In a preferred version of the process according to the invention, the laden second extractant obtained in step f) is subsequently used as the first extractant in step d). In this variant, the same extractant is first contacted for extraction with the laden polyamide particles having relatively low loading with monomers and/or oligomers from the postpolymerization and then with the laden polyamide particles having relatively high loading with monomers and/or oligomers from the hydrolytic polymerization. It is thus possible to distinctly reduce the amount of extractant to be worked up.

A specific version of the process according to the invention comprises the following steps:
treating the polyamide obtained in step e) with at least one second extractant in step f) to obtain a second extractant laden with monomers and/or oligomers,
using the laden extractant obtained in step f) for extraction in step d),
separating the laden extractant obtained in step d) into a fraction enriched in monomers and/or oligomers and a fraction depleted of monomers and/or oligomers,
feeding at least part of the fraction enriched in monomers and/or oligomers into the monomer composition provided in step a) or the reaction zone used for hydrolytic polymerization in step b),
using at least some of the fraction depleted of monomers and/or oligomers as the second extractant in step f).

### Step g)

Preferably, the extracted polyamide obtained in step f) is subjected to drying. Suitable apparatuses and processes for drying have been described above in step d), and reference here is made thereto. For drying, it is possible to use customary driers, for example countercurrent driers, crosscurrent driers, pan driers, tumble driers, paddle driers, crossflow driers, cone driers, tower driers, fluidized beds, etc. For example, the extracted pellets can be dried by contacting with dry air or a dry inert gas or a mixture thereof. Preference is given to using an inert gas for drying. A suitable version is batchwise drying in a tumble drier or cone drier under reduced pressure. A further suitable version is continuous drying in tubular driers, through which a gas which is inert under the drying conditions flows. In a specific version, drying is accomplished using at least one tower drier. Preferably, a hot inert gas which is inert under the postpolymerization conditions flows through the tower drier. A preferred inert gas is nitrogen.

The process according to the invention can be performed continuously or batchwise, and is preferably performed continuously.

The process according to the invention leads to polyamides having particularly advantageous properties. A suitable measure for the polymer properties achieved is the viscosity number. The viscosity number (Staudinger function, referred to as VN or J) is defined as VN=1/c×(η−ηₛ)/ηₛ. The viscosity number is directly related to the mean molar mass of the polyamide and gives information about the processibility of a polymer. The viscosity number can be determined to EN ISO 307 with an Ubbelohde viscometer. The viscosity number of the polyamide obtained by the process according to the invention is preferably 185 to 260 ml/g.

Preferably, the polyamide obtained has a residual monomer content of less than 0.1% and preferably less than 0.055% by weight, more preferably less than 0.03% by weight. The cyclic dimer content is preferably less than 0.1% by weight, more preferably less than 0.05% by weight, especially less than 0.025% by weight, most preferably less than 0.01% by weight.

Preferably, the polyamide obtained has a residual lactam content of not more than 0.055% by weight and a residual cyclic dimer content of not more than 0.025% by weight.

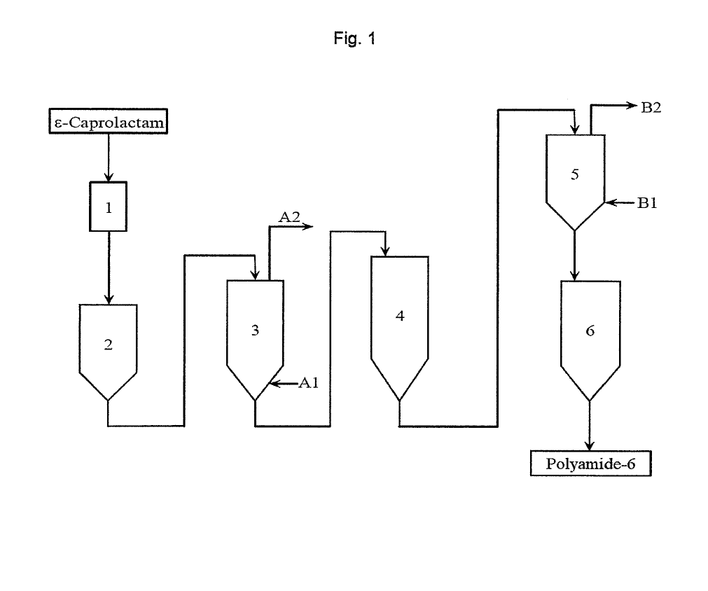

The process is illustrated in detail below by FIG. 1 and the examples.

FIG. 1 shows a schematic of one embodiment for performance of the process according to the invention.

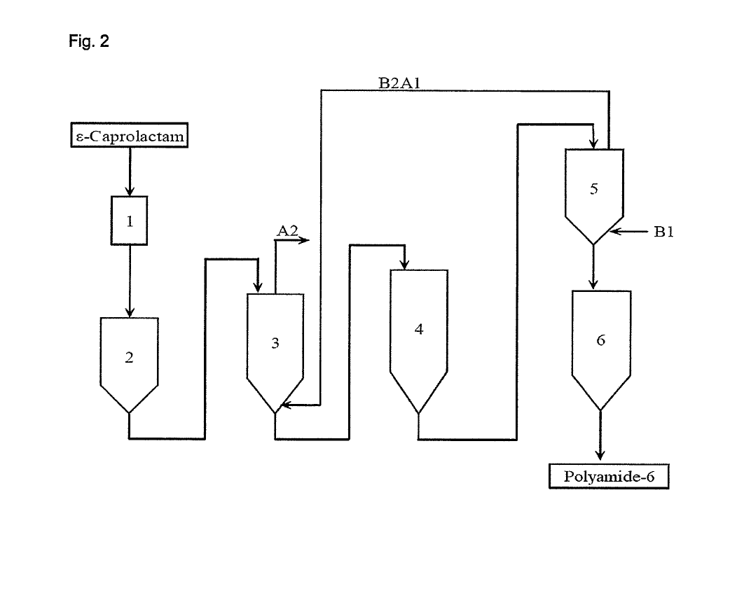

FIG. 2 shows a schematic of a further embodiment for performance of the process according to the invention, wherein laden extractant from the extraction (5) is fed into (3) for extraction.

In FIGS. 1 and 2, the following reference symbols are used:
1 preliminary pressure reactor
2 VK tube
3 extraction
4 solid phase polymerization
5 extraction
6 drying
A1, A2 inlet, outlet for the first extractant
B1, B2 inlet, outlet for the second extractant
B2A1 conduit for feeding laden extractant from (5) into (3)

### EXAMPLES

FIG. 1: Process according to the invention for preparation of polyamide-6

### Example 1

The feedstock used was polyamide-6 pellets produced on the industrial scale, having a viscosity number of 218 ml/g and a monomer content of 0.23%. The polyamide-6 pellets were produced via the process steps of preliminary reaction in the pressure reactor, melt polymerization in the VK tube, hot water extraction and heat treatment. 300 g of pellets were introduced into a 2 l reactor and extracted at 95° C. with 1000 g of water while stirring over 24 h. The extracted pellets were dried in a vacuum drying cabinet under a nitrogen blanket over 16 hours. The monomer content thereafter was 0.04%.

### Example 2

The feedstock used was polyamide-6 pellets produced on the industrial scale, having a viscosity number of 251 ml/g and a monomer content of 0.24%. The polyamide-6 pellets were produced via the process steps of preliminary reaction in the pressure reactor, melt polymerization in the VK tube, hot water extraction and heat treatment. 450 g of pellets were introduced into a 2 l reactor and extracted at 105° C. with 1500 g of water while stirring over 24 h. The extracted pellets were dried in a vacuum drying cabinet under a nitrogen blanket over 16 hours. The monomer content thereafter was 0.03%.

### Examples 3-5

The feedstock used was polyamide-6 pellets produced on the industrial scale, having a viscosity number of 218 ml/g and a monomer content of 0.23%. The polyamide-6 pellets were produced via the process steps of preliminary reaction in the pressure reactor, melt polymerization in the VK tube, hot water extraction and heat treatment. 625 g of pellets were introduced into a 2 l reactor and extracted at 95° C. while stirring with water over 30 h. In the course of this, the water was exchanged continuously at a flow rate of 2 l/h. Three 80 g fractions were taken from the extracted pellets, and these were dried successively in a drying apparatus. The drying apparatus consisted of a glass tube with a frit base, which was heated by means of an outer jacket. 80 g of pellets were introduced into the preheated glass tube, and hot nitrogen flowed through it over a particular residence time. After the residence time, the pellets were removed.

### Drying Conditions:

| | Example | Example | Example |
|---|---|---|---|
| | 3 | 4 | 5 |
| Residence time of pellets [kg/h] | 23 | 8 | 53 |
| Temperature of pellet bed [° C.] | 100 | 120 | 120 |
| Entrance temperature of nitrogen [° C.] | 100 | 120 | 120 |
| Volume flow rate of nitrogen [I (STP)/h] | 11 | 100 | 11 |
| Monomer content after drying [%] | 0.01 | 0.01 | 0.02 |

### Examples 6-8

The feedstock used was polyamide-6 pellets produced on the industrial scale, having a viscosity number of 250 ml/g, a monomer content of 0.23% and a dimer content of 220 ppm. The polyamide-6 pellets were produced via the process steps of preliminary reaction in the pressure reactor, melt polymerization in the VK tube, hot water extraction and heat treatment. These pellets were subjected to a further hot water extraction and then dried. The hot water extraction was performed in a continuous pulsed countercurrent extractor. The extractor had capacity for about 8 t of polyamide pellets. The extractant used was fresh deionized water. Pulsation is understood to mean that the water extractant is not conveyed continuously at constant flow rate into the reactor; instead, the water is fed in at high flow rate in a pulsed manner. The extractor was divided by three internal heat exchangers into three zones (upper, middle and bottom), in each of which it was possible to establish different temperatures.

The pellets leaving the extractor were run continuously through a centrifuge into a tower drier. The tower drier had capacity for about 16 t of polyamide pellets. The drying was effected with the aid of hot nitrogen, which was fed into the tower drier from the bottom.

### Extraction Conditions:

| | Example | Example | Example |
|---|---|---|---|
| | 6 | 7 | 8 |
| Throughput of pellets [kg/h] | 330 | 450 | 600 |
| Residence time of pellets [kg/h] | 24 | 18 | 13.5 |
| Throughput of extractant [kg/h] | 740 | 490 | 580 |
| Temperature at top [° C.] | 98 | 90 | 80 |
| Temperature in middle [° C.] | 98 | 98 | 95 |
| Temperature at bottom [° C.] | 95 | 95 | 95 |
| Monomer content after extraction [ppm] | 130 | 320 | 670 |

### Drying Conditions:

| | Example | Example | Example |
|---|---|---|---|
| | 6 | 7 | 8 |
| Throughput of pellets [kg/h] | 330 | 450 | 600 |
| Residence time of pellets [kg/h] | 49 | 36 | 27 |
| Temperature at top [° C.] | 120 | 118 | 105 |
| Temperature at bottom [° C.] | 120 | 120 | 125 |
| Nitrogen rate* [m³/h] | 2500 | 2500 | 2500 |
| Monomer content after drying [ppm] | 180 | 370 | 720 |
| Dimer content after drying [ppm] | 120 | 90 | 150 |

*measured at operating temperature = “temperature at bottom”

### Example 9

The feedstock used was polyamide-6 pellets produced on the industrial scale, having a viscosity number of 216 ml/g, a monomer content of 0.28% and a dimer content of 210 ppm. The polyamide-6 pellets were produced via the process steps of melt polymerization in the VK tube, hot water extraction and heat treatment. These pellets were subjected to a further hot water extraction and then dried. The hot water extraction was performed in a continuous countercurrent extractor. The extractor had capacity for about 44 t of polyamide pellets. The extractant used was water which had an organic carbon content (“TOC”, “total organic carbon”) of 500 ppm. The extractor had an extractant recycle line in the upper third, meaning that a portion of the extractant which leaves at the top of the extractor is recycled back into the upper third of the extractor.

The pellets leaving the extractor were run continuously through a centrifuge into a tower drier. The tower drier had capacity for about 40 t of polyamide pellets. The drying was effected with the aid of hot nitrogen, which was fed in below the upper third of the tower drier.

| | Example 9 |
|---|---|
| Throughput of pellets [kg/h] | 1380 |
| Residence time of pellets [kg/h] | 32 |
| Throughput of extractant [kg/h] | 1750 |
| Temperature at top [° C.] | 106 |
| Temperature in middle [° C.] | 99 |
| Temperature at bottom [° C.] | 99 |
| Monomer content after extraction [ppm] | 240 |

### Drying Conditions:

| | Example |
|---|---|
| | 9 |
| Throughput of pellets [kg/h] | 1380 |
| Residence time of pellets [kg/h] | 29 |
| Temperature at top [° C.] | 118 |
| Temperature at bottom [° C.] | 61 |
| Nitrogen rate* [m³/h] | 7500 |
| Monomer content after drying [ppm] | 310 |
| Dimer content after drying [ppm] | 40 |

*measured at operating temperature = “temperature at bottom”

1-20. (canceled)

21. A process for preparing polyamides, in which
a) Providing a monomer composition comprising at least one lactam or at least one aminocarbonitrile and/or oligomers of these monomers,
b) Converting the monomer composition provided in step a) in a hydrolytic polymerization at elevated temperature in the presence of water to obtain a reaction product comprising polyamide, water, unconverted monomers and oligomers,
c) Subjecting the reaction product obtained in step b) to shaping to obtain polyamide particles,
d) Treating the polyamide particles obtained in step c) with at least one first extractant,
e) Feeding the extracted polyamide particles obtained in step d) into a reaction zone for postpolymerization,
f) Treating the polyamide obtained in step e) with at least one second extractant.

22. The process according to claim 21, wherein the second extractant used in step f) comprises water or consists of water.

23. The process according to claim 21, wherein the temperature of the extractant during the treatment in step f) is within a range from 50 to less than 120° C.

24. The process according to claim 21, wherein the polyamide is in the solid state during the treatment in step f).

25. The process according to claim 21, wherein the extracted polyamide obtained in step f) is additionally subjected to a drying operation (step g)).

26. The process according to claim 21, wherein the monomer composition provided in step a) comprises e-caprolactam or 6-aminocapronitrile and/or oligomers of these monomers.

27. The process according to claim 21, wherein the conversion in step b) is effected in one or more stages.

28. The process according to claim 21, wherein the conversion in step b) is effected in two stages and an essentially vertical tubular reactor is used at least in the second stage.

29. The process according to claim 21, wherein the shaping in step c) comprises a pelletization.

30. The process according to claim 21, wherein the first extractant used in step d) comprises water or consists of water.

31. The process according to claim 21, wherein the polyamide obtained in step d) is subjected to a solid phase polymerization for postpolymerization in step e).

32. The process according to claim 31, wherein the reaction zone used for postpolymerization in step e) comprises a tubular reactor or consists of a tubular reactor.

33. The process according to claim 31, wherein the temperature during the postpolymerization in step e) is within a range from 120 to 185° C.

34. The process according to claim 31, wherein the postpolymerization in step e) is effected without mass transfer with the environment.

35. The process according to claim 21, wherein the components present in the laden first extractant obtained in step d) and/or the components present in the laden second extractant obtained in step f), selected from monomers and any dimers and oligomers, are isolated and recycled into step a) and/or b).

36. The process according to claim 21, wherein the laden second extractant obtained in step f) is used as the first extractant in step d).

37. The process according to claim 21, wherein the process is performed continuously.

38. A polyamide obtainable by a process as defined in claim 21.

39. A polyamide according to claim 38 having a residual lactam content of not more than 0.055% by weight and a residual cyclic dimer content of not more than 0.05% by weight.

40. A process for production of pellets, films, fibers or moldings which comprise utilizing the polyamide according to claim 38.
